(19) United States
(12) Patent Application Publication
(10) Pub. No.: US 2020/0034882 A1
(43) Pub. Date: Jan. 30, 2020

(54) SYSTEMS, METHODS, AND APPARATUSES FOR MAINTAINING DATA GRANULARITY WHILE PERFORMING DYNAMIC GROUP LEVEL MULTI-VARIATE TESTING IN A GROUP-BASED COMMUNICATION SYSTEM

(71) Applicant: SLACK TECHNOLOGIES, INC., San Francisco, CA (US)

(72) Inventors: Yongxing Deng, San Francisco, CA (US); Christopher Peterson, San Francisco, CA (US)

(21) Appl. No.: 16/177,039

(22) Filed: Oct. 31, 2018

Related U.S. Application Data
(60) Provisional application No. 62/703,820, filed on Jul. 26, 2018.

(51) Int. Cl. G06Q 30/02

(52) U.S. Cl. CPC G06Q 30/0257; G06Q 30/0244; H04L 12/1813; G06Q 30/0201; G06Q 30/0267; G06Q 30/0272

(57) ABSTRACT

Embodiments of the present disclosure provide methods, systems, apparatuses, and computer program products for conducting dynamic group-level multi-variate testing in a group-based communication system based on an experiment launch request received from an external application or a client device.

### CROSS REFERENCE TO RELATED APPLICATIONS

The present application claims priority to U.S. Provisional Application Ser. No. 62/703,820, titled “SYSTEMS, METHODS, AND APPARATUSES FOR MAINTAINING DATA GRANULARITY WHILE PERFORMING DYNAMIC GROUP LEVEL VARIANT TESTING IN A GROUP-BASED COMMUNICATION SYSTEM,” filed Jul. 26, 2018, the contents of which are incorporated herein by reference in their entirety.

### BACKGROUND

Various communication system developers struggle to design and execute communication system platform tests that effectively accumulate objective experiment data that can be leveraged to improve the system design and user experience. Applicant has identified a number of deficiencies and problems associated with conventional communication system experiment execution and optimization tools. Through applied effort, ingenuity, and innovation, many of these identified problems have been solved by developing solutions that are included in embodiments of the present disclosure, many examples of which are described in detail herein.

### BRIEF SUMMARY

Various embodiments of the present invention are directed to an apparatus configured for maintaining data granularity while performing dynamic group-level multi-variate testing in a group-based communication system. In one embodiment, a computing entity or apparatus is configured to receive an experiment launch request from a computing device. The experiment launch request is initiated by the computing device for creating a dynamic group-level variant testing experiment associated with a resource variant. In the embodiment, the experiment launch request is associated with experiment metadata comprising an experiment factor set and a scheduling factor set. The apparatus is further configured to parse the experiment launch request by a processor to identify a subject-level indicator among the experiment factor set. The apparatus is further configured to parse the experiment launch request by the processor to identify a control group ratio, a treatment group ratio, an experiment launch time, and an experiment period among the scheduling factor set. The apparatus is further configured to select a control group comprising a first plurality of user identifiers based on the control group ratio and the subject-level indicator, and a treatment group comprising a second plurality of user identifiers based on the treatment group ratio and the subject-level indicator. The apparatus is further configured to transmit, by the processor and beginning from the experiment launch time for the experiment period, a first resource configuration comprising a default resource configuration to the first plurality of client devices of the control group and an alternative resource configuration comprising the resource configuration variant to the second plurality of client devices of the treatment group. The apparatus is further configured to receive control group log data from the first plurality of client devices associated with the control group. The apparatus is further configured to receive treatment group log data from the second plurality of client devices associated with the treatment group. Further, the apparatus is configured to generate, by the processor, control group exposure data based on the control group log data and treatment group exposure data based on the treatment group log data.

The apparatus is optionally configured to transmit a subject-level metric table based on the subject-level indicator to the computing device. The apparatus is optionally configured to receive metric data from the computing device based on a target metric selected from the subject-level metric table. The apparatus is optionally configured to determine an experiment result based on the control group exposure data, the treatment group exposure data, and the metric data. Further, the apparatus is optionally configured to transmit the experiment result to the computing device.

In one embodiment, the experiment result comprises a participation rate, an action total value, an action mean value, or a latency distribution for the control group and the treatment group.

In one embodiment, the subject-level indicator of the experiment factor set is associated with a channel identifier, a group identifier, a visitor identifier, or a lead identifier.

In one embodiment, in circumstances where the subject-level indicator is associated with a channel identifier, the subject-level metric table rendered to the external application or the client device comprises channel-level metrics. In circumstances where the subject-level indicator is associated with a group identifier, the subject-level metric table rendered to the external application or the client device comprises group-level metrics. In circumstances where the subject-level indicator is associated with a visitor identifier, the subject-level metric table rendered to the external application or the client device comprises visitor-level metrics. In circumstances where the subject-level indicator is associated with a lead identifier, the subject-level metric table rendered to the external application or the client device comprises lead-level metrics.

In one embodiment, the group-level metrics comprise a conversion-to-paid rate. The visitor-level metrics comprise a visitor cookie total value. The lead-level metrics comprise a group creation value.

In one embodiment, the user accounts comprised in the control group and the treatment group are randomly selected by the processor or specifically selected by the processor based on an input received via the client device.

In one embodiment, the experiment factor set optionally comprises an experiment name metadata, an experiment summary metadata, an experiment description metadata, or an experiment owner identifier.

Other embodiments include corresponding systems, methods, and computer programs, configured to perform the operations of the apparatus, encoded on computer storage devices. The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF THE DRAWINGS

Having thus described the disclosure in general terms, reference will now be made to the accompanying drawings, which are not necessarily drawn to scale, and wherein:

FIG. 1 is a system architecture diagram of a group-based communication system configured to practice embodiments of the present disclosure;

FIG. 2 is an exemplary schematic diagram of a group-based communication server for use with embodiments of the present disclosure;

FIG. 3 illustrates exemplary flow diagram for generating exposure data, according to embodiments of the present disclosure;

FIG. 4 illustrates exemplary flow diagram for rendering an experiment result, according to embodiments of the present disclosure; and

FIG. 5 illustrates exemplary experiment result generating process according to embodiments of the present disclosure.

### DETAILED DESCRIPTION OF VARIOUS EMBODIMENTS

Various embodiments of the present disclosure now will be described more fully hereinafter with reference to the accompanying drawings, in which some, but not all embodiments of the disclosure are shown. Indeed, the disclosure may be embodied in many different forms and should not be construed as limited to the embodiments set forth herein; rather, these embodiments are provided so that this disclosure will satisfy applicable legal requirements. The term “or” is used herein in both the alternative and conjunctive sense, unless otherwise indicated. The terms “illustrative” and “exemplary” are used to be examples with no indication of quality level. Like numbers refer to like elements throughout.

### Overview

Various embodiments of the disclosure generally relate to a novel tool, service, and method for conducting dynamic group-level variant testing experiment in a group-based communication system. According to the present disclosure, a dynamic group-level variant testing experiment is initiated by dynamic group-level variant test circuitry running within an external application or on client device. The dynamic group-level variant testing experiment is structured to test a new user experience feature of the group-based communication system.

The dynamic group-level variant testing experiment is executed at a subject-level in contrast to other experiment tools. The subject-level may include a channel-level, a user-level, a visitor-level, or a lead-level as described in greater detail throughout this specification. Upon receiving an experiment launch request from the external application or the client device, the subject-level of the dynamic group-level variant testing experiment is determined by the dynamic group-level variant test circuitry. A control group and a treatment group are then selected for the appropriate subject-level. In some embodiments, a subject-level metric table associated with a selected user may be generated for storage and/or analysis by the external application developer that triggered the dynamic group-level variant testing experiment. The subject-level metric table may be used to select a target metric to evaluate the tested user experience feature. Further, depending on the target metric being selected, an experiment result may be generated for providing evaluated performance of the tested feature at certain subject-level to the external application developer or the user.

Obtaining statistically significant results when performing variant testing at a group-level is of little use when the number of groups is small, and the results obtained from a group-level variant testing using conventional methods may eliminate meaningful results of the variant testing at a user level. The computing time and computing resources necessary to programmatically obtain meaningful results becomes unrealistically large. Furthermore, in the time it takes to wait for a statistically significant amount of data, the collected data becomes obsolete or no longer meaningful. The present disclosure therefore reduces computing time and resources necessary for performing group-level variant testing while maintaining the quality and meaning of the data as well as user-level granularity.

In the present disclosure, because the dynamic group-level variant testing experiment may be launched at a certain subject-level, users within the same channel, same group, new visitors visiting the system without creating user accounts, lead users associated with new group creation events, may be presented with the same user experience (either containing the new feature/resource variant or not), which adds to the reliability of any resulted test data. This also allows an external application developer or experiment designer to evaluate different metrics at the subject-level and provide consistent user experience to users at the same subject-level. While the user accounts associated with the control group and the treatment group are selected at a certain subject-level, the corresponding subject-level metrics provided in the present disclosure to evaluate testing features may also be associated with each individual user. Therefore, features associated with the subject-level and the individual user level can both be captured, tracked, and evaluated according to the embodiments of the present disclosure.

### Definitions

As used herein, the terms “data,” “content,” “digital content,” “digital content object,” “information,” and similar terms may be used interchangeably to refer to data capable of being transmitted, received, and/or stored in accordance with embodiments of the present disclosure. Thus, use of any such terms should not be taken to limit the spirit and scope of embodiments of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like, sometimes referred to herein as a “network.” Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

The term “client device” refers to computer hardware and/or software that is configured to access a service made available by a server. The server is often (but not always) on another computer system, in which case the client device accesses the service by way of a network. Client devices may include, without limitation, smart phones, tablet computers, laptop computers, wearables, personal computers, enterprise computers, and the like.

“Group-based” is used herein to refer to a system, channel, message, or virtual environment that has security sufficient such that it is accessible only to a defined group of users. The group may be defined by common access credentials such as those of an organization or commercial enterprise. Access may further be facilitated by a validated request to join or an invitation to join transmitted by one group member user to another non-member user. Group identifiers (defined below) are used to associate data, information, messages, etc., with specific groups.

The term “group-based communication system” refers to a communications software platform and associated hardware that is configured to support and maintain a plurality of group-based communication interfaces and all associated functionality. Group-based communication system users are organized into organization groups (e.g., employees of different companies may be separate organization groups) and each group interacts with the system via a respective group-based communication interface. For example, the group-based communication system might support, among others, a Slack Corporation group-based communication interface and an ACME Corporation group-based communication interface. Example group-based communication systems comprise supporting servers, client devices, and external application servers.

The term “group-based communication interface” refers to a virtual communications environment configured to facilitate user interaction with a group-based communications system. Each group-based communication interface is accessible and viewable to a selected group of users, such as a group of employees of a business or organization (e.g., the Slack Corp. interface would be accessible and viewable to the Slack employees however the ACME Corporation group-based communication interface would not be accessible and viewable to Slack employees). The group-based communication interface includes a plurality of group-based communication channels (e.g., a marketing channel, sales channel, accounting channel, etc.), which are defined below.

The term “group-based communication channel” refers to a virtual communications environment or feed that is configured to display group-based messages posted by channel members (e.g., validated users accessing the environment using client devices) that are viewable only to the members of the group. The format of the group-based communication channel may appear differently to different members of the group-based communication channel; however, the content of the group-based communication channel (i.e., group-based messages) will be displayed to each member of the group-based communication channel. For instance, a common set of group-based messages will be displayed to each member of the respective group-based communication channel such that the content of the group-based communication channel (i.e., group-based messages) will not vary per member of the group-based communication channel.

The terms “group-based communication channel identifier” or “channel identifier” refer to one or more items of data by which a group-based communication channel may be identified. For example, a group-based communication channel identifier may comprise ASCII text, a pointer, a memory address, and the like.

The terms “group identifier” or “team identifier” refer to one or more items of data by which a group within a group-based communication system may be identified. For example, a group identifier may comprise ASCII text, a pointer, a memory address, and the like.

The terms “visitor identifier” refers to one or more items of data associated with a visitor cookie by which a visitor within a group-based communication system may be identified. For example, a visitor identifier may comprise ASCII text, a pointer, a memory address, and the like.

The term “lead identifier” refers to one or more items of data by which a user associated with a new group or team creation within a group-based communication system may be identified. For example, a lead identifier may comprise ASCII text, a pointer, a memory address, and the like.

The term “lead-level” refers to one or more items of data by which a particular traversal through a user, group, or team creation flow may be identified, where the flow comprises a series of graphical interfaces. For example, a lead-level may comprise ASCII text, a pointer, a memory address, and the like. For example, as a client device associated with a lead identifier navigates, by interacting with the group-based communication system, through a series of graphical interfaces rendered for display on the client device, the series of graphical interfaces associated with a user, group, or team creation flow or funnel, the lead identifier is associated with a particular traversal through different graphical interfaces (i.e., stages) in the user-profile, team, or group creation funnel (i.e., each traversal or journey through a series of graphical interface is a different lead-level). It will be appreciated that the graphical interfaces traversed by different client devices result in different leads. As such, one lead-level experiment may involve a subset of graphical interfaces of a creation flow/funnel, the subset of graphical interfaces associated with a particular first lead. Another lead-level experiment may involve a different or overlapping subset of graphical interfaces of the creation flow/funnel, the different or overlapping subset of graphical interfaces associated with a unique lead that differs from the particular first lead.

The term “user” should be understood to refer to an individual, group of individuals, business, organization, and the like; the users referred to herein are accessing a group-based communication or messaging system using client devices.

The terms “user profile,” “user account,” and “user account details” refer to information associated with a user, including, for example, a user identifier, one or more group-based communication channel identifiers associated with group-based communication channels that the user has been granted access to, one or more group identifiers for groups with which the user is associated, one or more organization identifiers for organizations with which the user is associated, an indication as to whether the user is an owner of any group-based communication channels, an indication as to whether the user has any group-based communication channel restrictions, a plurality of messages, an emoji, a plurality of conversations, a plurality of conversation topics, an avatar, an email address, a real name (e.g., John Doe), a username (e.g., jdoe), a password, a real name, a time zone, a status, and the like. The user account details can include a subset designation of user credentials, such as, for example, login information for the user including the user's username and password.

As used herein, the terms “group-based message” and “message” refer to any electronically generated device rendered objects provided by a user using a client device and that is configured for display within a group-based communication channel. Message communications may include any text, image, video, audio or combination thereof provided by a user (using a client device). For instance, the user may provide a group-based message that includes text as well as an image and a video within the group-based message as message contents. In such a case, the text, image, and video would comprise the group-based message or device rendered object. Each message sent or posted to a group-based communication channel of the group-based communication system includes metadata comprising the following: a sending user identifier, a message identifier, message contents, a group identifier, and a group-based communication channel identifier. Each of the foregoing identifiers may comprise ASCII text, a pointer, a memory address, and the like.

Group-based communication system users are organized into organization groups (e.g., employees of each company may be a separate organization group) and each organization group may access a group-based communication interface having one or more group-based communication channels (explained below) to which users may be assigned or which the users may join (e.g., group-based communication channels may represent departments, geographic locations such as offices, product lines, user interests, topics, issues, and/or the like). A group identifier may be used to facilitate access control for a message (e.g., access to the message, such as having the message return as part of search results in response to a search query, may be restricted to those users having the group identifier associated with their user profile). The group identifier may be used to determine context for the message (e.g., a description of the group, such as the name of an organization and/or a brief description of the organization, may be associated with the group identifier).

Group-based communication system users may join group-based communication channels. Some group-based communication channels may be globally accessible to those users having a particular organizational group identifier associated with their user profile (i.e., users who are members of the organization). Access to some group-based communication channels may be restricted to members of specified groups, whereby the group-based communication channels are accessible to those users having a particular group identifier associated with their user profile. The group-based communication channel identifier may be used to facilitate access control for a message (e.g., access to the message, such as having the message return as part of search results in response to a search query, may be restricted to those users having the group-based communication channel identifier associated with their user profile, or who have the ability to join the group-based communication channel). The group-based communication channel identifier may be used to determine context for the message (e.g., a description of the group-based communication channel, such as a description of a project discussed in the group-based communication channel, may be associated with the group-based communication channel identifier).

The term “private group-based communication channel” refers to a group-based communication channel with restricted access such that it is not generally accessible and/or searchable by other members of the group-based communication system. For example, only those users or administrators who have knowledge of and permission to access (e.g., a group-based communication channel identifier for the private group-based communication channel is associated with their user profile after the user has been validated/authenticated) the private group-based communication channel may view content of the private group-based communication channel.

The term “external application” refers to a software program, platform, or service that is configured to communicate with the group-based communication system for providing service to a client device via a group-based communication interface. The external application operates on a compiled code base or repository that is separate and distinct from that which supports the group-based communication system. In some embodiments, the external application may communicate with the group-based communication system, and vice versa, through one or more application program interfaces (APIs). In some embodiments, the external application receives tokens or other authentication credentials that are used to facilitate secure communication between the external application and the group-based communication system in view of group-based communication system network security layers or protocols (e.g., network firewall protocols). Once connected with the remote networked device, the external application may transmit messages through the group-based communication system to a targeted client device.

The terms “dynamic group-level variant testing experiment”, “split testing experiment”, “bucket testing experiment,” “multi-variate testing” and/or similar terms refer to a controlled experiment that is configured to compare two or more group-based communication system versions (e.g., version A and version B) that are varied by one or more variables or user experience features. A dynamic group-level variant testing experiment is executed by a tool or service that programmatically collects data associated with the single variable that is varied between versions. Such data may then be analyzed to determine which of the versions is optimal. In embodiments, the two or more group-based communication system versions may be varied by more than a single variable or user experience feature.

The term “experiment launch request” refers to an electronically generated request from a client device for creating a dynamic group-level variant testing experiment in a group-based communication system. An experiment launch request may include experiment metadata that is used by the group-based communication system to build and execute a dynamic group-level variant testing experiment.

The terms “new feature” or “resource variant” refer to a distinctive characteristic of a product or service, that a service provider intends to incorporate into its existing product or service for providing an improved or altered user experience. For example, an application developer may generate two versions of a user interface for testing. The first version of the user interface may be an existing user interface, while a second version includes a new feature (e.g., a different configuration of user interface layout) that the application developer is considering for incorporation into its existing product or service.

The term “experiment metadata” refers to one or more items of data associated with the dynamic group-level variant testing experiment that a user or a service developer would like to launch. The experiment metadata provides information regarding details of the dynamic group-level variant testing experiment. The experiment metadata may include an experiment factor set and a scheduling factor set.

The term “experiment factor set” refers to one or more items of digital content associated with a basic setting of a dynamic group-level variant testing experiment and may include a subject-level indicator indicating a level (e.g., user-level, group-level, visitor-level, or lead-level) of the subject for conducting the experiment. The experiment factor set may further include an experiment name metadata, an experiment summary metadata, an experiment description metadata, or an experiment owner identifier. The “experiment name metadata” indicates what name a user or a service developer would like to assign to a specific dynamic group-level variant testing experiment. The “experiment summary metadata” indicates a short description (e.g., a one-line description of the experiment) a user or a service developer would like to assign to a specific dynamic group-level variant testing experiment. The “experiment description metadata” indicates a long description (e.g., a detailed description of the experiment) a user or a service developer would like to assign to a specific dynamic group-level variant testing experiment. The “experiment owner identifier” indicates one or more items of data by which a user or a service developer initiating a dynamic group-level variant testing experiment within a group-based communication system may be identified. For example, an experiment owner identifier may comprise ASCII text, a pointer, a memory address, and the like.

The term “scheduling factor set” refers to one or more items of digital content associated with a scheduling setting for defining a time a feature for conducting a dynamic group-level variant testing experiment. The scheduling factor set may include a control group ratio, a treatment group ratio, an experiment launch time, and an experiment period for defining sizes for the control group and treatment group and a time period for conducting the experiment.

The term “subject level indicator” refers to one or more items of digital content that is used for indicating which subject-level of a group-based communication system a dynamic group-level variant testing experiment is intended. The subject level indicator may indicate that the dynamic group-level variant testing experiment is to be performed on a channel-level, a user-level, a group-level, a visitor-level, or a lead-level. In an example circumstance where a dynamic group-level variant testing experiment is performed on a group-level, the control group and the treatment group may each be associated with a specific group identifier. A default or conventional interface component may be exposed to all users associated with a specific group assigned as the control group while a new interface component (i.e., a new feature) is exposed to all users associated with another group that is assigned as the treatment group. In circumstances where the dynamic group-level variant testing experiment is performed on a visitor-level, the control group and the treatment group may each be associated with visitor cookies, where the default interface component is exposed to a ratio of visitors randomly assigned as the control group and the new feature is exposed to a ratio of visitors randomly assigned as the treatment group. In circumstances where the dynamic group-level variant testing experiment is to be performed on a lead-level, the control group and treatment group may each be associated with a specific lead identifier.

The term “control group” refers to a group of testing subjects selected to be provided with a default or conventional feature in the context of a dynamic group-level variant testing experiment. The control group may be randomly selected by a group-based communication server in a group-based communication system or manually selected by a user or an service developer using a client device.

The term “control group ratio” refers to a programmatically generated value that is used for determining a plurality of user accounts to be associated with the control group. The control group ratio may indicate how many users to be assigned to the control group and exposed to a dynamic group-level variant testing experiment. The control group ratio may be received by a group-based communication server and transmitted by the user or the service developer when providing instructions for setting up the dynamic group-level variant testing experiment. For example, in circumstances where the control group ratio is 10%, the group-based communication server may determine to assign 10% of the total user accounts to the control group and to expose those users associated with selected user accounts to the default user experience.

The term “treatment group” refers to a group of testing subjects selected to be provided with a new feature in the context of dynamic group-level variant testing experiment. The treatment group may be randomly selected from a group-based communication server in a group-based communication system or be manually selected by a user or an application developer using a client device.

The term “treatment group ratio” refers to a programmatically generated value that is used for determine a plurality of user accounts to be associated with the treatment group, where the plurality of user accounts are each associated with a user being assigned to the treatment group. The treatment group ratio may indicate how many users to be assigned to the treatment group and exposed to a dynamic group-level variant testing experiment. The treatment group ratio may be received by a group-based communication server transmitted by the user or the service developer for setting up dynamic group-level variant testing environment for the experiment. For example, in circumstances where the treatment group ratio is 10%, the group-based communication server may determine to assign 10% of the total user accounts at the identified subject-level to the treatment group and to expose only those users associated with selected user accounts to the new feature.

The term “experiment launch time” refers to a programmatically generated timestamp that a user or a service developer intends for start/launching a dynamic group-level variant testing experiment. The experiment launch time may be received by a group-based communication server and transmitted by the user or the service developer when setting up a dynamic group-level variant testing experiment.

The term “experiment period” refers to a time period that a user or a service developer intends for conduct a dynamic group-level variant testing experiment. The experiment period may be received by a group-based communication server and transmitted by the user or the service developer for setting up a dynamic group-level variant testing experiment.

The term “control feature” refers to a component of a product or service (e.g., a group-based communication system) that is presented to a control group instead of the new feature that is exposed to the treatment group.

The terms “user experience” or “resource configuration” refers to the overall experience provided, by way of a client device, to a user using a particular product, system, or service provided by a service provider. User experience encompasses all aspects of a user's interactions with the product or service. User experience includes a user's perceptions of the product or the system such as utility, ease of use, and efficiency. User experience is dynamic as it is constantly modified over time due to changes of features incorporated in the product or the system.

The term “default user experience” refers to a user experience comprising control features provided to a client device for serving as a baseline of a user's interactions with the existing product or service.

The term “new user experience” refers to a user experience comprising new features provided to a client device for testing a user's interactions associated with the new feature intended to be changed or incorporated in the existing product or service.

The term “control group log data” refers to one or more items of digital content associated with timestamps generated by a group-based communication server whenever a user's interaction is engaged with the control feature existed in the default user experience.

The term “treatment group log data” refers to one or more items of digital content associated with timestamps generated by a group-based communication server whenever a user's interaction is engaged with the new feature an application developer or a user would like to test and incorporate in the new user experience.

The term “control group exposure data” refers to one or more items of digital content collected from client devices being assigned to the control group during the experiment period of a dynamic group-level variant testing experiment. The control group exposure data is associated with users' interactions with the control feature existed in the default user experience.

The term “treatment group exposure data” refers to one or more items of digital content collected from client devices being assigned to the treatment group during the experiment period of a dynamic group-level variant testing experiment. The treatment group exposure data is associated with users' interactions with the new feature incorporated in the new user experience.

The term “subject-level metric table” refers to a programmatically generated table that comprises a plurality of metrics to be provided to a user or a service provider for selection. The subject-level metric table is generated based on the subject-level indicator associated with a channel identifier, a group identifier, a visitor identifier, or a lead identifier. In circumstances where the experiment is performed on a channel-level, a subject level metric table comprising channel-level metrics may be generated, where the term “channel-level metrics” refers to metrics that may be used for evaluating a dynamic group-level variant testing experiment performed on a channel-level. In circumstances where the experiment is performed on a group-level, a subject level metric table comprising group-level metrics may be generated, where the term “group-level metrics” refers to metrics that may be used for evaluating a dynamic group-level variant testing experiment performed on a group-level. In circumstances where the experiment is performed on a visitor-level, a subject level metric table comprising visitor-level metrics may be generated, where the term “visitor-level metrics” refers to metrics that may be used for evaluating a dynamic group-level variant testing experiment performed on a visitor-level. In circumstances where the experiment is performed on a lead-level, a subject level metric table comprising lead-level metrics may be generated, where the term “lead-level metrics” refers to metrics that may be used for evaluating a dynamic group-level variant testing experiment performed on a lead-level.

The term “metric data” refers to one or more items of data representing a metric used for measuring performance of the control group or the treatment group.

The term “target metric” refers to an accessing standard used for measuring performance of the control group or the treatment group. The target metric may be selected by a user or a service developer initiating the dynamic group-level variant testing performance from a subject0level metric table provided to the user or the service developer.

The term “experiment result” refers to one or more items of digital content generated by a group-based communication server for presenting analytical results of a dynamic group-level variant testing experiment to a client device associated with a user or a service developer initiating the experiment. The experiment result may include analytical results generated based on metric data, the control group exposure data, and the treatment group exposure data collected during the experiment period. The experiment results may comprise a participation rate, an action total value, an action mean value, or a latency distribution, that are provided to the user or the service developer to determine whether the new feature tested should be incorporated in its existing product or service.

The term “participation rate” refers to a programmatically generated value based on dividing a number of user accounts engaged in user interactions with the new feature by a total number of user accounts assigned to a control group or a treatment group.

The term “action total value” refers to a value programmatically generated based on a total number of control group log data or the treatment group log data. The action mean value indicates effective actions where users within the control group or the treatment group engaged with the control feature or the new feature.

The term “action mean value” refers to a value programmatically generated based on an average number of control group log data or the treatment group log data performed by a user assigned in the control group or the treatment group. The action mean value indicates effective average actions where a user within the control group or the treatment group engaged with the control feature or the new feature.

The term “latency distribution” refers to a figure programmatically generated based on probability density functions or cumulative distribution functions of latency distribution for the control group or the treatment group. The latency distribution indicates latency time in operating the control feature associated with the control group and the new feature associated with the treatment group.

The term “conversion-to-paid rate” refers to a programmatically generated value associated with a group-level metric indicating a ratio of conversion actions from click to paid among users within a control group or a treatment group.

The term “visitor cookie total value” refers to a programmatically generated value associated with a visitor-level metric indicating a number of visitor cookies collected during the experiment period from users within a control group or a treatment group.

The term “group creation value” refers to a programmatically generated value associated with a lead-level metric indicating a number of new group creations among users within a control group or a treatment group.

### Example System Architecture

Methods, apparatuses, and computer program products of the present disclosure may be embodied by any of a variety of devices. For example, the method, apparatus, and computer program product of an example embodiment may be embodied by a networked device (e.g., an enterprise platform), such as a server or other network entity, configured to communicate with one or more devices, such as one or more client devices. Additionally or alternatively, the computing device may include fixed computing devices, such as a personal computer or a computer workstation. Still further, example embodiments may be embodied by any of a variety of mobile devices, such as a portable digital assistant (PDA), mobile telephone, smartphone, laptop computer, tablet computer, wearable, or any combination of the aforementioned devices.

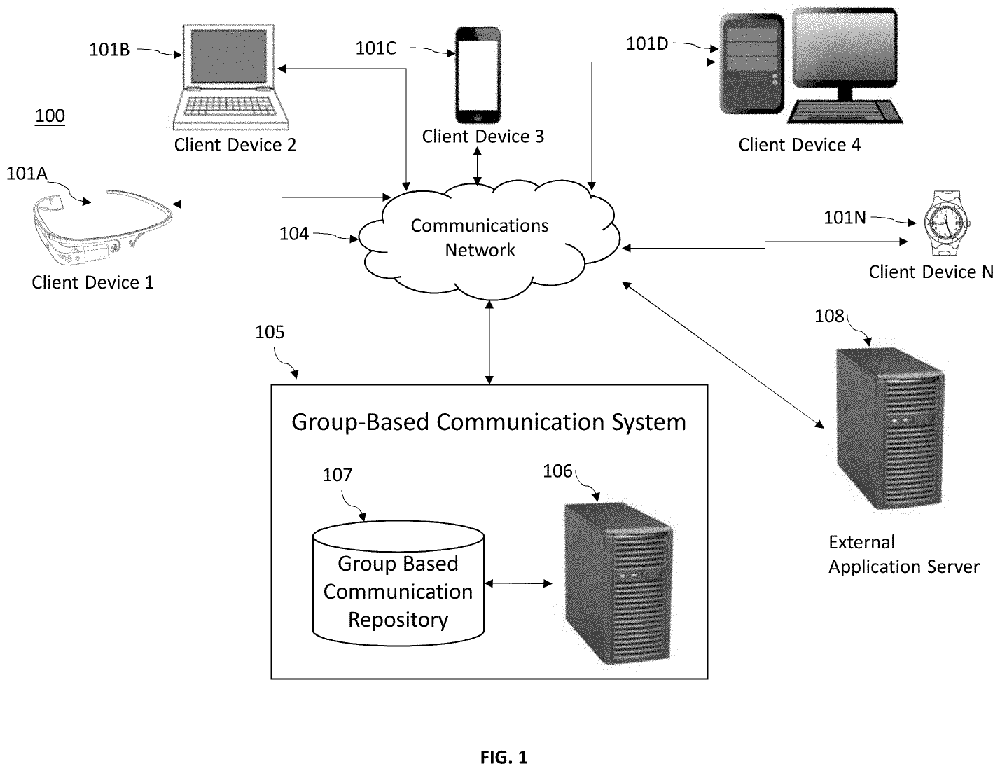

FIG. 1 illustrates an example computing system 100 within which embodiments of the present disclosure may operate. Users may access a group-based communication system 105 via a communications network 104 using client devices 101A-101N. An external application server 108 may interact with a group-based communication system 105 via a communications network 104. The group-based communication system 105 may comprise a group-based communication server 106 in communication with at least one group-based communication repository 107.

Communications network 104 may include any wired or wireless communication network including, for example, a wired or wireless local area network (LAN), personal area network (PAN), metropolitan area network (MAN), wide area network (WAN), or the like, as well as any hardware, software and/or firmware required to implement it (such as, e.g., network routers, etc.). For example, communications network 104 may include a cellular telephone, an 802.11, 802.16, 802.20, and/or WiMax network. Further, the communications network 104 may include a public network, such as the Internet, a private network, such as an intranet, or combinations thereof, and may utilize a variety of networking protocols now available or later developed including, but not limited to TCP/IP based networking protocols. For instance, the networking protocol may be customized to suit the needs of the group-based communication system. In some embodiments, the protocol is a custom protocol of JSON objects sent via a Websocket channel. In some embodiments, the protocol is JSON over RPC, JSON over REST/HTTP, and the like.

The group-based communication server 106 may be embodied as a computer or computers as known in the art. The group-based communication server 106 may provide for receiving of electronic data from various sources, including but not necessarily limited to the client devices 101A-101N or external application server 108. For example, the group-based communication server 106 may be operable to receive experiment launch requests provided by the client devices 101A-101N for initiating a dynamic group-level variant testing experiment. For another example, the group-based communication server 106 may be operable to receive experiment launch requests provided by external application server for initiating a dynamic group-level variant testing experiment.

The group-based communication repository 107 may be embodied as a data storage device such as a Network Attached Storage (NAS) device or devices, or as a separate database server or servers. The group-based communication repository 107 includes information accessed and stored by the group-based communication server 106 to facilitate the operations of the group-based communication system 105. For example, the group-based communication repository 107 may include, without limitation, a plurality of messaging communication features organized among a plurality of group-based communication channels, and/or the like.

The client devices 101A-101N may be any computing device as defined above. Electronic data received by the group-based communication server 106 from the client devices 101A-101N may be provided in various forms and via various methods. For example, the client devices 101A-101N may include desktop computers, laptop computers, smartphones, netbooks, tablet computers, wearables, and the like.

In embodiments where a client device 101A-101N is a mobile device, such as a smart phone or tablet, the client device 101A-101N may execute an “app” to interact with the group-based communication system 105. Such apps are typically designed to execute on mobile devices, such as tablets or smartphones. For example, an app may be provided that executes on mobile device operating systems such as iOS®, Android®, or Windows®. These platforms typically provide frameworks that allow apps to communicate with one another and with particular hardware and software components of mobile devices. For example, the mobile operating systems named above each provide frameworks for interacting with location services circuitry, wired and wireless network interfaces, user contacts, and other applications. Communication with hardware and software modules executing outside of the app is typically provided via application programming interfaces (APIs) provided by the mobile device operating system.

Additionally or alternatively, the client device 101A-101N may interact with the group-based communication system 105 via a web browser. As yet another example, the client device 101A-101N may include various hardware or firmware designed to interface with the group-based communication system 105.

In some embodiments of an exemplary group-based communication system 105, a message or group-based message may be sent from a client device 101A-101N to a group-based communication system 105. In various implementations, the message may be sent to the group-based communication system 105 over communications network 104 directly by a client device 101A-101N, the message may be sent to the group-based communication system 105 via an intermediary such as a message server, and/or the like. For example, the client device 101A-101N may be a desktop, a laptop, a tablet, a smartphone, and/or the like that is executing a client application (e.g., a group-based communication app). In one implementation, the message may include data such as a message identifier, sending user identifier, a group identifier, a group-based communication channel identifier, message contents (e.g., text, emojis, images, links), attachments (e.g., files), message hierarchy data (e.g., the message may be a reply to another message), third party metadata, and/or the like. In one embodiment, the client device 101A-101N may provide the following example message, substantially in the form of a (Secure) Hypertext Transfer Protocol (“HTTP(S)”) POST message including eXtensible Markup Language (“XML”) formatted data, as provided below:

```
POST /authrequest.php HTTP/1.1
Host: www.server.com
Content-Type: Application/XML
Content-Length: 667
<?XML version = “1.0” encoding = “UTF-8”?>
<auth_request>
  <timestamp>2020-12-31 23:59:59</timestamp>
  <user_accounts_details>
    <user_account_credentials>
      <user_name>ID_user_1</user_name>
      <password>abc123</password>
      //OPTIONAL <cookie>cookieID</cookie>
      //OPTIONAL <digital_cert_link>www.mydigitalcertificate.com/
  JohnDoeDaDoeDoe@gmail.com/mycertifcate.dc</digital_cert_link>
      //OPTIONAL <digital_certificate>_DATA_</digital_certificate>
    </user_account_credentials>
  </user_accounts_details>
  <client_details> //iOS Client with App and Webkit
      //it should be noted that although several client details
      //sections are provided to show example variants of client
      //sources, further messages will include only on to save
      //space
    <client_IP>10.0.0.123</client_IP>
    <user_agent_string>Mozilla/5.0 (iPhone; CPU iPhone OS 7_1_1 like Mac OS X)
  AppleWebKit/537.51.2 (KHTML, like Gecko) Version/7.0 Mobile/11D201
  Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1</client_OS_version>
    <client_app_type>app with webkit</client_app_type>
    <app_installed_flag>true</app_installed_flag>
    <app_name>NickName.app</app_name>
    <app_version>1.0 </app_version>
    <app_webkit_name>Mobile Safari</client_webkit_name>
    <client_version>537.51.2</client_version>
  </client_details>
  <client_details> //iOS Client with Webbrowser
    <client_IP>10.0.0.123</client_IP>
    <user_agent_string>Mozilla/5.0 (iPhone; CPU iPhone OS 7_1_1 like Mac OS X)
  AppleWebKit/537.51.2 (KHTML, like Gecko) Version/7.0 Mobile/11D201
  Safari/9537.53</user_agent_string>
    <client_product_type>iPhone6,1</client_product_type>
    <client_serial_number>DNXXX1X1XXXX</client_serial_number>
    <client_UDID>3XXXXXXXXXXXXXXXXXXXXXXXXD</client_UDID>
    <client_OS>iOS</client_OS>
    <client_OS_version>7.1.1 </client_OS_version>
    <client_app_type>web browser</client_app_type>
    <client_name>Mobile Safari</client_name>
    <client_version>9537.53</client_version>
  </client_details>
  <client_details> //Android Client with Webbrowser
    <client_IP>10.0.0.123</client_IP>
    <user_agent_string>Mozilla/5.0 (Linux; U; Android 4.0.4; en-us; Nexus S Build/IMM76D)
  AppleWebKit/534.30 (KHTML, like Gecko) Version/4.0 Mobile Safari/534.30</user_agent_string>
    <client_product_type>Nexus S</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Android</client_OS>
    <client_OS_version>4.0.4</client_OS_version>
    <client_app_type>web browser</client_app_type>
    <client_name>Mobile Safari</client_name>
    <client_version>534.30</client_version>
  </client_details>
  <client_details> //Mac Desktop with Webbrowser
    <client_IP>10.0.0.123</client_IP>
    <user_agent_string>Mozilla/5.0 (Macintosh; Intel Mac OS X 10_9_3) AppleWebKit/537.75.14
  (KHTML, like Gecko) Version/7.0.3 Safari/537.75.14</user_agent_string>
    <client_product_type>MacPro5,1</client_product_type>
    <client_serial_number>YXXXXXXXXZ</client_serial_number>
    <client_UDID>FXXXXXXXXX-XXXX-XXXX-XXXX-XXXXXXXXXXXXX</client_UDID>
    <client_OS>Mac OS X</client_OS>
    <client_OS_version>10.9.3</client_OS_version>
    <client_app_type>web browser</client_app_type>
    <client_name>Mobile Safari</client_name>
    <client_version>537.75.14</client_version>
  </client_details>
  <message>
    <message_identifier>ID_message_10</message_identifier>
    <team_identifier>ID_team_1</team_identifier>
    <channel_identifier>ID_channel_1</channel_identifier>
    <contents>That is an interesting invention. I have attached a copy our patent policy.</contents>
    <attachments>patent_policy.pdf</attachments>
  </message>
</auth_request>
```

The group-based communication system 105 comprises at least one group-based communication server 106 that may create a storage message based upon the received message to facilitate message indexing and storage in a group-based communication repository 107. In one implementation, the storage message may include data such as a message identifier, a group identifier, a group-based communication channel identifier, a sending user identifier, topics, responses, message contents, attachments, message hierarchy data, third party metadata, conversation primitive data, and/or the like. For example, the group-based communication server 106 may provide the following example storage message, substantially in the form of a HTTP(S) POST message including XML-formatted data, as provided below:

```
POST /storage_message.php HTTP/1.1
Host: www.server.com
Content-Type: Application/XML
Content-Length: 667
<?XML version = “1.0” encoding = “UTF-8”?>
<storage_message>
  <message_identifier>ID_message_10</message_identifier>
  <team_identifier>ID_team_1</team_identifier>
  <channel_identifier>ID_channel_1</channel_identifier>
  <sending_user_identifier>ID_user_1</sending_user_identifier>
  <topics>
    <topic>inventions</topic>
    <topic>patents</topic>
    <topic>policies</topic>
  </topics>
  <responses>
    <response>liked by ID_user_2</response>
    <response>starred by ID_user_3</response>
  </responses>
  <contents>That is an interesting invention. I have attached a
  copy our patent policy.</contents>
  <attachments>patent_policy.pdf</attachments>
  <conversation_primitive>
    conversation includes messages: ID_message_8,
      ID_message_9, ID_message_10,
      ID_message_11, ID_message_12
  </conversation_primitive>
</storage_message>
```

In embodiments, a group identifier as defined above may be associated with the message.

In embodiments, a group-based communication channel identifier as defined above may be associated with the message.

In embodiments, a sending user identifier as defined above may be associated with the message. In one implementation, the message may be parsed (e.g., using PHP commands) to determine a sending user identifier of the user who sent the message.

In embodiments, topics may be associated with the message. In one implementation, the message contents may be parsed (e.g., using PHP commands) to determine topics discussed in the message. For example, hashtags in the message may channels associated with the message. In another example, the message may be analyzed (e.g., by itself, with other messages in a conversation primitive) or parsed using a machine learning technique, such as topic modeling, to determine topics associated with the message.

In embodiments, data indicating responses may be associated with the message. For example, responses to the message by other users may include reactions (e.g., selection of an emoji associated with the message, selection of a “like” button associated with the message), clicking on a hyperlink embedded in the message, replying to the message (e.g., posting a message to the group-based communication channel in response to the message), downloading a file associated with the message, sharing the message from one group-based communication channel to another group-based communication channel, pinning the message, starring the message, and/or the like. In one implementation, data regarding responses to the message by other users may be included with the message, and the message may be parsed (e.g., using PHP commands) to determine the responses. In another implementation, data regarding responses to the message may be retrieved from a database. For example, data regarding responses to the message may be retrieved via a MySQL database command similar to the following:

SELECT messageResponses
FROM MSM_Message
WHERE messageID = ID_message_10.

For example, data regarding responses to the message may be used to determine context for the message (e.g., a social score for the message from the perspective of some user). In another example, data regarding responses to the message may be analyzed to determine context regarding the user (e.g., the user's expertise in a topic may be determined based on the responses to the user's message regarding the topic).

In embodiments, attachments may be included with the message. If there are attachments, files may be associated with the message. In one implementation, the message may be parsed (e.g., using PHP commands) to determine file names of the attachments. For example, file contents may be analyzed to determine context for the message (e.g., a patent policy document may indicate that the message is associated with the topic “patents”).

In embodiments, third party metadata may be associated with the message. For example, third party metadata may provide additional context regarding the message or the user that is specific to a company, group, group-based communication channel, and/or the like. In one implementation, the message may be parsed (e.g., using PHP commands) to determine third party metadata. For example, third party metadata may indicate whether the user who sent the message is an authorized representative of the group-based communication channel (e.g., an authorized representative may be authorized by the company to respond to questions in the group-based communication channel).

In embodiments, a conversation primitive may be associated with the message. In one implementation, a conversation primitive is an element used to analyze, index, store, and/or the like messages. For example, the message may be analyzed by itself, and may form its own conversation primitive. In another example, the message may be analyzed along with other messages that make up a conversation, and the messages that make up the conversation may form a conversation primitive. In one implementation, the conversation primitive may be determined as the message, a specified number (e.g., two) of preceding messages and a specified number (e.g., two) of following messages. In another implementation, the conversation primitive may be determined based on analysis of topics discussed in the message and other messages (e.g., in the channel) and/or proximity (e.g., message send order proximity, message send time proximity) of these messages.

In embodiments, various metadata, determined as described above, and/or the contents of the message may be used to index the message (e.g., using the conversation primitive) to facilitate various facets of searching (i.e., search queries that return results from group-based communication repository 107). In one implementation, a storage message may be sent from group-based communication server 106 to facilitate indexing in group-based communication repository 107. In another implementation, metadata associated with the message may be determined and the message may be indexed in group-based communication repository 107. In one embodiment, the message may be indexed such that a company's or a group's messages are indexed separately (e.g., in a separate index associated with the group and/or company that is not shared with other groups and/or companies). In one implementation, messages may be indexed at a separate distributed repository (e.g., to facilitate data isolation for security purposes).

If there are attachments associated with the message, file contents of the associated files may be used to index such files in group-based communication repository 107 to facilitate searching. In one embodiment, the files may be indexed such that a company's or a group's files are indexed at a separate distributed repository.

### Example Apparatus for Implementing Embodiments of the Present Disclosure

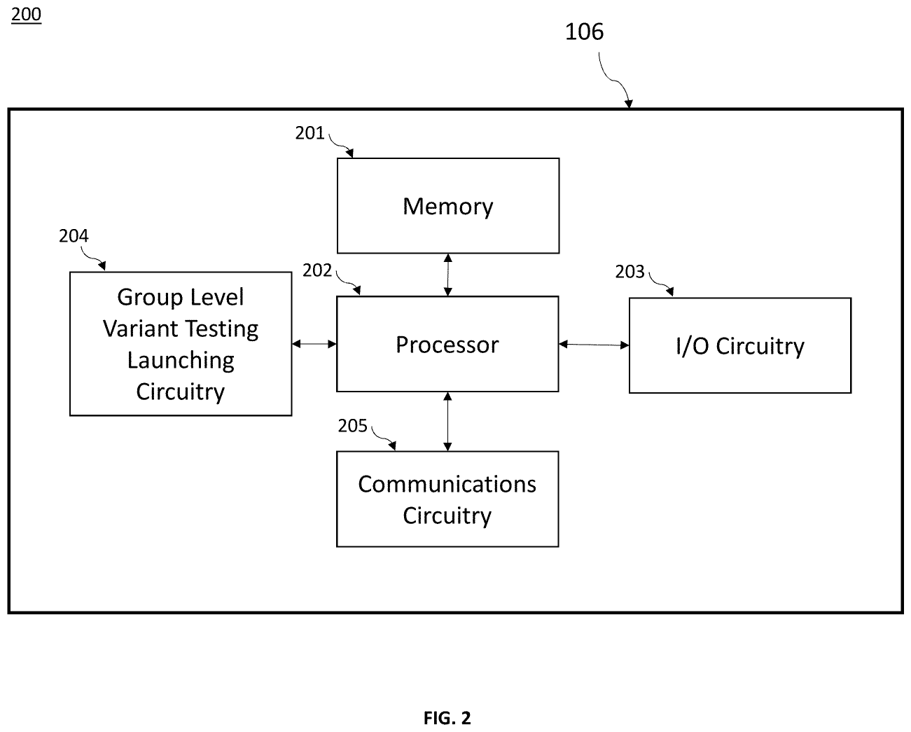

FIG. 2 illustrates an exemplary schematic diagram of a group-based communication server 200 that may be embodied by one or more computing systems. The group-based communication server 200 may include a processor 202, a memory 201, input/output circuitry 203, communications circuitry 205, and dynamic group-level variant testing launching circuitry 204. The group-based communication server 200 may be configured to execute the operations described herein. Although the components are described with respect to functional limitations, it should be understood that the particular implementations necessarily include the use of particular hardware. It should also be understood that certain of the components described herein may include similar or common hardware. For example, two sets of circuitry may both leverage use of the same processor, network interface, storage medium, or the like to perform their associated functions, such that duplicate hardware is not required for each set of circuitry. The use of the term “circuitry” as used herein with respect to components of the apparatus should therefore be understood to include particular hardware configured to perform the functions associated with the particular circuitry as described herein.

The term “circuitry” should be understood broadly to include hardware and, in some embodiments, software for configuring the hardware. For example, in some embodiments, “circuitry” may include processing circuitry, storage media, network interfaces, input/output devices, and the like. In some embodiments, other elements of the group-based communication server 200 may provide or supplement the functionality of particular circuitry. For example, the processor 202 may provide processing functionality, the memory 201 may provide storage functionality, the communications circuitry 205 may provide network interface functionality, and the like.

In some embodiments, the processor 202 (and/or co-processor or any other processing circuitry assisting or otherwise associated with the processor) may be in communication with the memory 201 via a bus for passing information among components of the apparatus. The memory 201 may be non-transitory and may include, for example, one or more volatile and/or non-volatile memories. In other words, for example, the memory may be an electronic storage device (e.g., a computer readable storage medium). The memory 201 may be configured to store information, data, content, applications, instructions, or the like, for enabling the apparatus to carry out various functions in accordance with example embodiments of the present disclosure.

The processor 202 may be embodied in a number of different ways and may, for example, include one or more processing devices configured to perform independently. Additionally or alternatively, the processor may include one or more processors configured in tandem via a bus to enable independent execution of instructions, pipelining, and/or multithreading. The use of the term “processing circuitry” may be understood to include a single core processor, a multi-core processor, multiple processors internal to the apparatus, and/or remote or “cloud” processors.

In an example embodiment, the processor 202 may be configured to execute instructions stored in the memory 201 or otherwise accessible to the processor. Alternatively, or additionally, the processor may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor is embodied as an executor of software instructions, the instructions may specifically configure the processor to perform the algorithms and/or operations described herein when the instructions are executed.

In some embodiments, the group-based communication server 200 may include input/output circuitry 203 that may, in turn, be in communication with processor 202 to provide output to the user and, in some embodiments, to receive an indication of a user input. The input/output circuitry 203 may comprise a user interface and may include a display and may comprise a web user interface, a mobile application, a client device, a kiosk, or the like. In some embodiments, the input/output circuitry 203 may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 201, and/or the like).

The communications circuitry 205 may be any means such as a device or circuitry embodied in either hardware or a combination of hardware and software that is configured to receive and/or transmit data from/to a network and/or any other device, circuitry, or module in communication with the group-based communication server 200. In this regard, the communications circuitry 205 may include, for example, a network interface for enabling communications with a wired or wireless communication network. For example, the communications circuitry 205 may include one or more network interface cards, antennae, buses, switches, routers, modems, and supporting hardware and/or software, or any other device suitable for enabling communications via a network. Additionally or alternatively, the communication interface may include the circuitry for interacting with the antenna(s) to cause transmission of signals via the antenna(s) or to handle receipt of signals received via the antenna(s).

The dynamic group-level variant testing launching circuitry 204 includes hardware configured to support a group-based communication system in launching a channel-based, a group-based, a visitor-based, or a lead-based dynamic group-level variant testing experiment. The dynamic group-level variant testing launching circuitry 204 may utilize processing circuitry, such as the processor 202, to perform these actions. The dynamic group-level variant testing launching circuitry 204 may send and/or receive data from group-based communication repository 107. In some implementations, the sent and/or received data may be of enterprise-based digital content objects organized among a plurality of group-based communication channels. It should also be appreciated that, in some embodiments, the dynamic group-level variant testing launching circuitry 204 may include a separate processor, specially configured field programmable gate array (FPGA), or application specific interface circuit (ASIC).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Any suitable computer-readable storage medium may be utilized including non-transitory hard disks, CD-ROMs, flash memory, optical storage devices, or magnetic storage devices.

### Example Processes for Conducting Dynamic Group-Level Variant Testing in a Group-Based Communication System

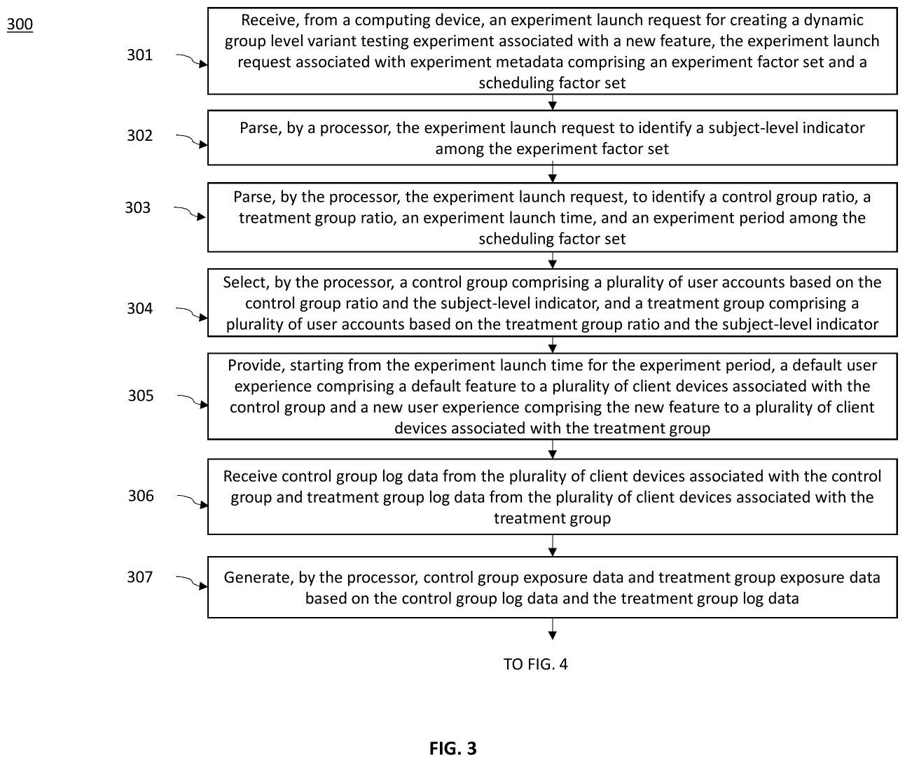

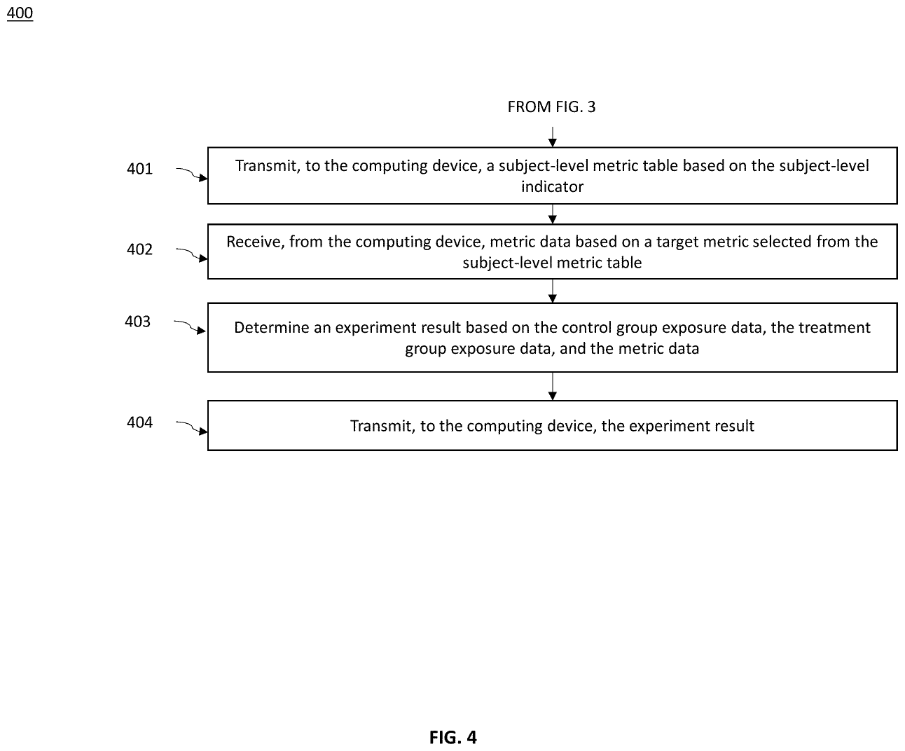

FIG. 3 illustrates exemplary flow diagram for generating control group exposure data and treatment group exposure data, according to embodiments of the present disclosure. As described in greater detail in association with FIG. 4, the generated control group exposure data and treatment group exposure data are used to provide statistics for generating a dynamic group-level variant testing experiment result. The method 300 begins at operation 301 by receiving an experiment launch request for creating a dynamic group-level variant testing experiment associated with a new feature from an external application or a client device.

In one embodiment, the experiment launch request may be received from an external application designer by way of a designated user interface associated with the external application. The external application designer may launch a dynamic group-level variant testing by selecting, clicking, or entering launching instructions using the designated user interface. In another embodiment, the experiment launch request may be received from a client device by way of a group-based communication user interface associated with the user using the client device. The user may launch a dynamic group-level variant testing by selecting, clicking, or entering launching instructions using the group-based communication user interface provided in a group-based communication system.

The experiment launch request is associated with experiment metadata comprising an experiment factor set and a scheduling factor set. The experiment factor set comprises information for setting up the dynamic group-level variant testing environment and determining testing subject level and the scheduling factor set comprises information for determining the size/scale of testing groups and when to start/finish the dynamic group-level variant testing experiment.

In one embodiment, the experiment factor set comprises a subject-level indicator for determining a subject-level, such as a channel-level, a group-level, a visitor-level, or a lead-level, to be a testing unit for launching same feature to a subject-level set of users. In another example, the experiment factor set may further comprise an experiment name metadata, an experiment summary metadata, an experiment description metadata, or an experiment owner identifier, each may be entered by a user using an external application or a client device, for example, via an input field of a group message. In such an embodiment, the experiment name metadata is a concise name that is created by the user and may later be used in computer program codes for launching the dynamic group-level variant testing experiment. The experiment summary metadata and experiment description metadata servers as a short/brief description and a long/detailed description of the dynamic group-level variant experiment for the user to track or record established experiments. The experiment owner identifier is associated with the external application or the client device for identifying which external application or the client device initiated the experiment launch request.

In one embodiment, the scheduling factor set comprises a control group ratio, a treatment group ratio, an experiment launch time, and an experiment period. The control group ratio and the treatment group ratio each determines a ratio of user accounts among total user accounts to be selected for each group. For example, the control group ratio may be set as 10% and the treatment group ratio may also be set as 10%. In such an example, if there is total of 100,000 user accounts established in the group-based communication system, a set of 10,000 user accounts is selected from the total user accounts to be assigned to the control group, another set of 10,000 user accounts is selected from the total user accounts to be assigned to the treatment group, while the remaining set of 80,000 user accounts remain unassigned in the system. The experiment launch time is associated with a timestamp for starting the dynamic group-level variant testing experiment and the experiment period corresponds to a duration for conducting the dynamic group-level variant testing experiment.

The method 300 continues at operation 302 by parsing the experiment launch request to identify a subject-level indicator among the experiment factor set by the processor.

The method 300 continues at operation 303 by parsing the experiment launch request to identify a control group ratio, a treatment group ratio, an experiment launch time, and an experiment period among the scheduling factor set by the processor.

The method 300 continues at operation 304 by selecting a control group comprising a plurality of user accounts based on the control group ratio and the subject-level indicator, and a treatment group comprising a plurality of user accounts based on the treatment group ratio and the subject-level indicator. In the above embodiment where a control group ratio is 10%, a treatment group ratio is 10%, and a total user account value is 100,000, the 10,000 user accounts assigned to the control group and treatment groups are selected based on the subject-level indicator. For example, if the subject-level indicator is associated with a channel identifier, user accounts associated with a selected channel are assigned to the control group or the treatment group exclusively. That allows user accounts associated with the same channel to experience the same user experience and prevents users within the same channel from having varied exposure to a control feature and a new feature or resource variant upon launching a dynamic group-level variant testing experiment.

The method 300 continues at operation 305 by transmitting, starting from the experiment launch time and extended through the experiment period, a default resource configuration comprising a control configuration to a plurality of client devices associated with the control group. Operation 305 further provides a new resource configuration comprising the alternative resource variant to a plurality of client devices associated with the treatment group.

The method 300 continues at operation 306 by receiving control group log data from the plurality of client devices associated with the control group and treatment group log data from the plurality of client devices associated with the treatment group. In the embodiment, the control group log data is collected from the control group starting from the experiment launch time for the experiment period, while the treatment log data is collected from the treatment group for the same experiment period. The collected control group log data and treatment group log data may later be used to generate data for each group for analyzing and comparing different groups of users' response to the tested new feature and the control feature.

The method 300 continues at operation 307 by generating control group exposure data and treatment group exposure data based on the control group log data and the treatment group log data.

FIG. 4 illustrates exemplary flow diagram for rendering an experiment result based on a target metric selected from a subject-level metric table via an external application or a client device. In one embodiment, the method 300 may further continue by method 400 for rendering an experiment result based on the control group exposure data and the treatment group exposure data collected from method 300.

The method 400 begins at operation 401 by rendering a subject-level metric table to the external application or the client device based on the subject-level indicator. In one embodiment, a channel-level metric table may be rendered to the external application or the client device based on a channel identifier among the experiment factor set. The channel-level metric table comprises channel-level metrics that are only meaningful for evaluation at a channel-level. For example, a new feature associated with a color of the interface of a channel as a new feature may only be meaningful for users associated with the channel being tested for a new color of interface. In such an example, a channel-level metric may be a channel traffic value for evaluating a channel's traffic load at a channel-level.

In another embodiment, a group-level metric table may be rendered to the external application or the client device based on a group identifier among the experiment factor set. The group-level metric table comprises group-level metrics that are only meaningful for evaluation at a group-level. For example, a group-level metric may be a conversion-to-paid ratio associated with a tested advertisement for evaluating a ratio of user accounts actually conducted transactions via clicking the advertisement to a group of total user accounts that have seen the advertisement at a group-level.

In another embodiment, a visitor-level metric table may be rendered to the external application or the client device based on a visitor identifier among the experiment factor set. The visitor-level metric table comprises visitor-level metrics that are only meaningful for evaluation at a visitor-level. For example, a visitor-level metric may be a visitor cookie total value for calculating a total number of visitor cookies collected during the experiment period. The visitor cookie total value may be used to evaluated the tested feature for determining how successful the new feature may solicit new visitors at a visitor-level.

In another embodiment, a lead-level metric table may be rendered to the external application or the client device based on a lead identifier among the experiment factor set. The lead-level metric table comprises lead-level metrics that are only meaningful for evaluation at a lead-level. For example, a lead-level metric may be a group creation value for calculating a total number of groups being created during the experiment period. The group creation value may be used to evaluated the tested feature for determining how successful the new feature may solicit lead users to create new groups in the group-based communication system at a lead-level.

The method 400 begins at operation 402 by receiving metric data from the external application or the client device based on a target metric selected from the subject-level metric table. The user using the experiment application of the client device may select a target metric from the subject-level metric table via clicking on the target metric for evaluating the target metric at the subject-level.

The method 400 begins at operation 403 by determining an experiment result based on the control group exposure data, the treatment group exposure data, and the metric data. In one embodiment, the experiment result may comprise a participation rate, an action total value, an action mean value, or a latency distribution for the control group and the treatment group. The participation rate is calculated based on a number of user accounts associated with users that have actually interacted with the tested feature among a total number of user accounts being exposed to the tested feature. The total action value is calculated based on a sum of total actions associated with the interaction of the tested feature. The action mean value is calculated based on averaging the action total value over the participating user accounts associated with users that have actually interacted with the tested feature. The latency distribution is generated based on a probability distribution of participation rate changes over the experiment period for monitoring users' responses to the tested feature over time.

The method 400 ends at operation 404 by rendering the experiment result to the external application or the client device.

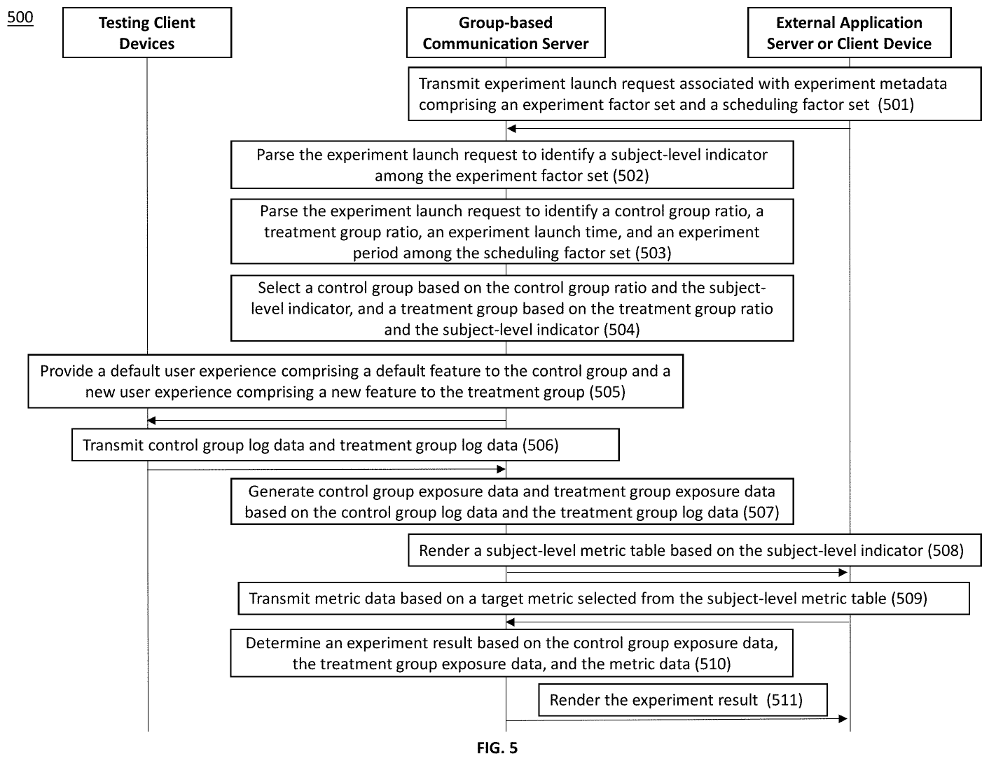

FIG. 5 illustrates exemplary experiment result generating process executed by an external application server 108, a client device launching the dynamic group-level variant testing (such as one of client devices 101A-101N shown in FIG. 1), a group-based communication server 106, and a plurality of testing client devices (such as 101A-101N shown in FIG. 1) selected for rendering the dynamic group-level variant testing.

An external application server (such as an external application server shown in FIG. 1) or a client device (such as one of the client devices 101A-101N shown in FIG. 1) may be configured to transmit experiment launch request for creating a dynamic group-level variant testing experiment associated with a new feature. The experiment launch request is associated with experiment metadata comprising an experiment factor set and a scheduling factor set at operation 501.

The group-based communication server (such as a group-based communication server shown in FIG. 1) may be configured to parse the experiment launch request to identify a subject-level indicator among the experiment factor set at operation 502.

The group-based communication server may further be configured to parse the experiment launch request to identify a control group ratio, a treatment group ratio, an experiment launch time, and an experiment period among the scheduling factor set at operation 503.

The group-based communication server may further be configured to select a control group comprising a plurality of user accounts based on the control group ratio and the subject-level indicator, and a treatment group comprising a plurality of user accounts based on the treatment group ratio and the subject-level indicator at operation 504.

The group-based communication server may further be configured to provide a default user experience comprising a default feature to a plurality of testing client devices selected as the control group and a new user experience comprising a new feature to a plurality of testing client devices selected as the treatment group at operation 505.

The selected testing client devices may be configured to transmit the respective control group log data and the treatment group log data to the group-based communication server at operation 506.

The group-based communication server may further be configured to generate control group exposure data and treatment group exposure data based on the control group log data and the treatment group log data at operation 507.

The group-based communication server may further be configured to render a subject-level metric table to the external application or the client device launching the dynamic group-level variant testing based on the subject-level indicator at operation 508.

The external application server or client device may further transmit metric data to the group-based communication server based on a target metric selected from the subject-level metric table at operation 509.

The group-based communication server may further be configured to determine an experiment result based on the control group exposure data, the treatment group exposure data, and the metric data at operation 510.

Finally, the group-based communication server may further be configured to render the experiment result to the external application server or the client device launching the dynamic group-level variant testing experiment.

### Additional Implementation Details

Although an example processing system has been described in FIG. 2, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer storage medium for execution by, or to control the operation of, information/data processing apparatus. Alternatively, or in addition, the program instructions can be encoded on an artificially-generated propagated signal, e.g., a machine-generated electrical, optical, or electromagnetic signal, which is generated to encode information/data for transmission to suitable receiver apparatus for execution by an information/data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “data processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application-specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them. The apparatus and execution environment can realize various different computing model infrastructures, such as web services, distributed computing and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory or a random access memory or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer need not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., a CRT (cathode ray tube) or LCD (liquid crystal display) monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a client computer having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML page) to a client device (e.g., for purposes of displaying information/data to and receiving user input from a user interacting with the client device). Information/data generated at the client device (e.g., a result of the user interaction) can be received from the client device at the server.

While this specification contains many specific implementation details, these should not be construed as limitations on the scope of any disclosures or of what may be claimed, but rather as descriptions of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results. In certain implementations, multitasking and parallel processing may be advantageous.

### CONCLUSION

Many modifications and other embodiments of the disclosures set forth herein will come to mind to one skilled in the art to which these disclosures pertain having the benefit of the teachings presented in the foregoing descriptions and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed is:

1. An apparatus for performing dynamic group-level variant testing in a group-based communication system, the apparatus comprising at least one processor and at least one memory including computer program code, the at least one memory and the computer program code configured to, with the at least one processor, cause the apparatus to:
receive, by a processor and from a computing device, an experiment launch request for creating a group-level variant testing experiment associated with a resource configuration variant, the experiment launch request associated with experiment metadata comprising an experiment factor set and a scheduling factor set;
parse, by the processor, the experiment launch request to identify a subject-level indicator among the experiment factor set;
parse, by the processor, the experiment launch request to identify a control group ratio, a treatment group ratio, an experiment launch time, and an experiment period among the scheduling factor set;
select, by the processor, a control group comprising a first plurality of user identifiers based on the control group ratio and the subject-level indicator, and a treatment group comprising a second plurality of user identifiers based on the treatment group ratio and the subject-level indicator;
transmit, by the processor and beginning from the experiment launch time for the experiment period, a first resource configuration comprising a default resource configuration to the first plurality of client devices of the control group and an alternative resource configuration comprising the resource configuration variant to the second plurality of client devices of the treatment group;
receive control group log data from the first plurality of client devices of the control group and treatment group log data from the second plurality of client devices of the treatment group; and
generate, by the processor, control group exposure data and treatment group exposure data based on the control group log data and the treatment group log data.

2. The apparatus of claim 1, the at least one memory and the computer program code configured to, with the at least one processor, further cause the apparatus to:
transmit, to the computing device, a subject-level metric table based on the subject-level indicator;
receive, from the computing device, metric data based on a target metric selected from the subject-level metric table;
determine, by the processor, an experiment result based on the control group exposure data, the treatment group exposure data, and the metric data; and
transmit, to the computing device, the experiment result.

3. The apparatus of claim 2, wherein the experiment result comprises a participation rate, an action total value, an action mean value, or a latency distribution for the control group and the treatment group.

4. The apparatus of claim 2, wherein the subject-level indicator of the experiment factor set is associated with a channel identifier, a group identifier, a visitor identifier, or a lead identifier.

5. The apparatus of claim 4, wherein:
in circumstances where the subject-level indicator is associated with the channel identifier, the subject-level metric table comprises channel-level metrics;
in circumstances where the subject-level indicator is associated with the group identifier, the subject-level metric table comprises group-level metrics;
in circumstances where the subject-level indicator is associated with the visitor identifier, the subject-level metric table comprises visitor-level metrics; and
in circumstances where the subject-level indicator is associated with the lead identifier, the subject-level metric table comprises lead-level metrics.

6. The apparatus of claim 5, wherein the group-level metrics comprise a conversion-to-paid rate.

7. The apparatus of claim 5, wherein the visitor-level metrics comprise a visitor cookie total value.

8. The apparatus of claim 5, wherein the lead-level metrics comprise a group creation value.

9. The apparatus of claim 1, wherein the plurality of user accounts comprised in the control group and the plurality of user accounts comprised in the treatment group are randomly selected by the processor or specifically selected by the processor based on an input received via the computing device.

10. The apparatus of claim 1, wherein the experiment factor set further comprises an experiment name metadata, an experiment summary metadata, an experiment description metadata, or an experiment owner identifier.

11. A method for conducting dynamic group-level variant testing in a group-based communication system, the method comprising:
receiving, by a processor and from a computing device, an experiment launch request for creating a dynamic group-level variant testing experiment associated with a new resource variant, the experiment launch request associated with experiment metadata comprising an experiment factor set and a scheduling factor set;
parsing, by a processor, the experiment launch request to identify a subject-level indicator among the experiment factor set;
parsing, by the processor, the experiment launch request to identify a control group ratio, a treatment group ratio, an experiment launch time, and an experiment period among the scheduling factor set;
selecting, by the processor, a control group comprising a first plurality of user identifiers based on the control group ratio and the subject-level indicator, and a treatment group comprising a second plurality of user identifiers based on the treatment group ratio and the subject-level indicator;
transmitting, by the processor and beginning from the experiment launch time for the experiment period, a first resource configuration comprising a default resource configuration to the first plurality of client devices of the control group and an alternative resource configuration comprising the resource configuration variant to the second plurality of client devices of the treatment group;
receiving control group log data from the first plurality of client devices associated with the control group and treatment group log data from the second plurality of client devices associated with the treatment group; and
generating, by the processor, control group exposure data and treatment group exposure data based on the control group log data and the treatment group log data.

12. The method of claim 11, further comprising:
transmitting, by the processor and to the computing device, a subject-level metric table based on the subject-level indicator;
receiving, by the processor and from the computing device, metric data based on a target metric selected from the subject-level metric table;
determining, by the processor, an experiment result based on the control group exposure data, the treatment group exposure data, and the metric data; and
transmitting, to the computing device, the experiment result.

13. The method of claim 12, wherein the experiment result comprises a participation rate, an action total value, an action mean value, or a latency distribution for the control group and the treatment group.

14. The method of claim 12, wherein the subject-level indicator of the experiment factor set is associated with a channel identifier, a group identifier, a visitor identifier, or a lead identifier.

15. The method of claim 14, wherein:
in circumstances where the subject-level indicator is associated with the channel identifier, the subject-level metric table comprises channel-level metrics;
in circumstances where the subject-level indicator is associated with the group identifier, the subject-level metric table comprises group-level metrics;
in circumstances where the subject-level indicator is associated with the visitor identifier, the subject-level metric table comprises visitor-level metrics; and
in circumstances where the subject-level indicator is associated with the lead identifier, the subject-level metric table comprises lead-level metrics.

16. The method of claim 15, wherein the group-level metrics comprise a conversion-to-paid rate.

17. The method of claim 15, wherein the visitor-level metrics comprise a visitor cookie total value.

18. The method of claim 15, wherein the lead-level metrics comprise a group creation value.

19. The method of claim 11, wherein the plurality of user accounts comprised in the control group and the plurality of user accounts comprised in the treatment group are randomly selected by the processor or specifically selected by the processor based on a user's manual selection via the client device.

20. The method of claim 11, wherein the experiment factor set further comprises an experiment name metadata, an experiment summary metadata, an experiment description metadata, or an experiment owner identifier.
